(19) United States
(12) Patent Application Publication
(10) Pub. No.: US 2002/0184051 A1
(43) Pub. Date: Dec. 5, 2002

(54) Pharmaceutical packaging on demand

(75) Inventors: Philip Shi-Lung Yu, Chappagua, NY (US); Barry Edward Willner, Briarcliff Manor, NY (US); Edith Helen Stern, Yorktown Heights, NY (US); David Perry Greene, Ossining, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/871,282

(22) Filed: May 31, 2001

(51) Int. Cl. G06F 17/60; A45C 11/00

(52) U.S. Cl. 705/2; 206/37

(57) ABSTRACT

A medication package and method, system, and computer program product for making same is provided. In one embodiment, medications are grouped into dosage groups. Each dosage group contains at least one element of medication, such as a pill or capsule. Furthermore, each element of medication in a dosage group should be taken by a patient at substantially the same time as other elements of medication in the same dosage group. Each dosage group of medication is placed into a separate compartment in a package. The compartments of the package are covered and labeled with an indication of the time for which the associated medications within the compartment should be taken by a patient. The compartments are covered in such a manner such that removal of a dosage group from the package provides an indication to a patient that the medications in the dosage group have been taken by the patient.

### BACKGROUND OF THE INVENTION

1. Technical Field

The present invention relates to methods and systems for packaging medication and to computer software for controlling the packaging of medication.

2. Description of Related Art

Scientific medicine at the beginning of the 19^{th} century was heroic medicine. All diseases were thought to result from an excess of fluids, and the cure was to relieve the body of the excesses through bloodletting and purging. However, such treatments were painful and debilitating. Since the scientific community was doing little to improve medicine and since the public was rebelling against these painful and debilitating treatments of heroics, a void developed in medical treatment. Lay health reformers and practitioners rushed in with “theories” of their own. Their treatments included water, electricity, manipulation of animal magnetism, and vegetable compounds.

It was not until the end of the 19^{th} century that scientific advances began to catch up with the medical needs of the public. Civil War hospital experiences and the new theories of bacteriology slowly produced fundamental changes in medical practice. Medical training adapted to the growing knowledge base of the profession, and by the end of the century, America was well on its way to having the best medical care in the world.

During the 20^{th} century great scientific advancements were made in the field of pharmacology to provide more effective cures and treatments for diseases previously thought to be incurable. As medicine continued to advance, more and more medications were developed to treat a great variety of ailments. Today, the number of medications available to treat diseases is enormous.

Although medicine has advance significantly, methods of directing and ensuring that patients take their medications has not improved significantly frown the “snake oil” days of the 19^{th} century. The current method of instructing patients in taking their medication and ensuring that the medication is taken is much the same as it has been: the doctor prescribes a treatment, provides the patient with written or oral directions on how to take the medication, and then relies on the patient to implement the instructions. Such a method may be fine when the patient is required to take only one or two medications for a limited amount of time. However, with the aging of the population and the ever increasing number of diseases for which pharmaceutical treatment is available, such a method is inadequate.

For instance, memory problems become more acute in elderly individuals. This fact coupled with the fact that many elderly individuals may need to take more than a half dozen medications several times a day for prolonged periods of time make it likely that some dosages will be missed or that extra dosages will be taken. For individuals with serious illnesses or diseases missing a dose of medication could be seriously detrimental to their health. Similarly, many medications are dangerous if taken in too high of concentrations, thus taken too many doses is also a problem. Therefore, it would be desirable to have an improved medication package and an improved method and system for creating medication packaging such that the risk that a patient forgets to take a dosage of medication or takes too many doses is reduced.

### SUMMARY OF THE INVENTION

The present invention provides a medication package and method, system, and computer program product for making same. In one embodiment, medications are grouped into dosage groups. Each dosage group contains at least one element of medication, such as a pill or capsule. Furthermore, each element of medication in a dosage group should be taken by a patient at substantially the same time as other elements of medication in the same dosage group. Each dosage group of medication is placed into a separate compartment in a package. The compartments of the package are covered and labeled with an indication of the time for which the associated medications within the compartment should be taken by a patient. The compartments are covered in such a manner such that removal of a dosage group from the package provides an indication to a patient that the medications in the dosage group have been taken by the patient.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a diagram illustrating a pharmaceutical packaging and delivery system in accordance with the present invention;

FIGS. 5-7 depict diagrams illustrating pharmaceutical packaging in accordance with the present invention; and

FIG. 8 depicts a process flow and program function illustrating a method for packaging mediations in accordance with the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

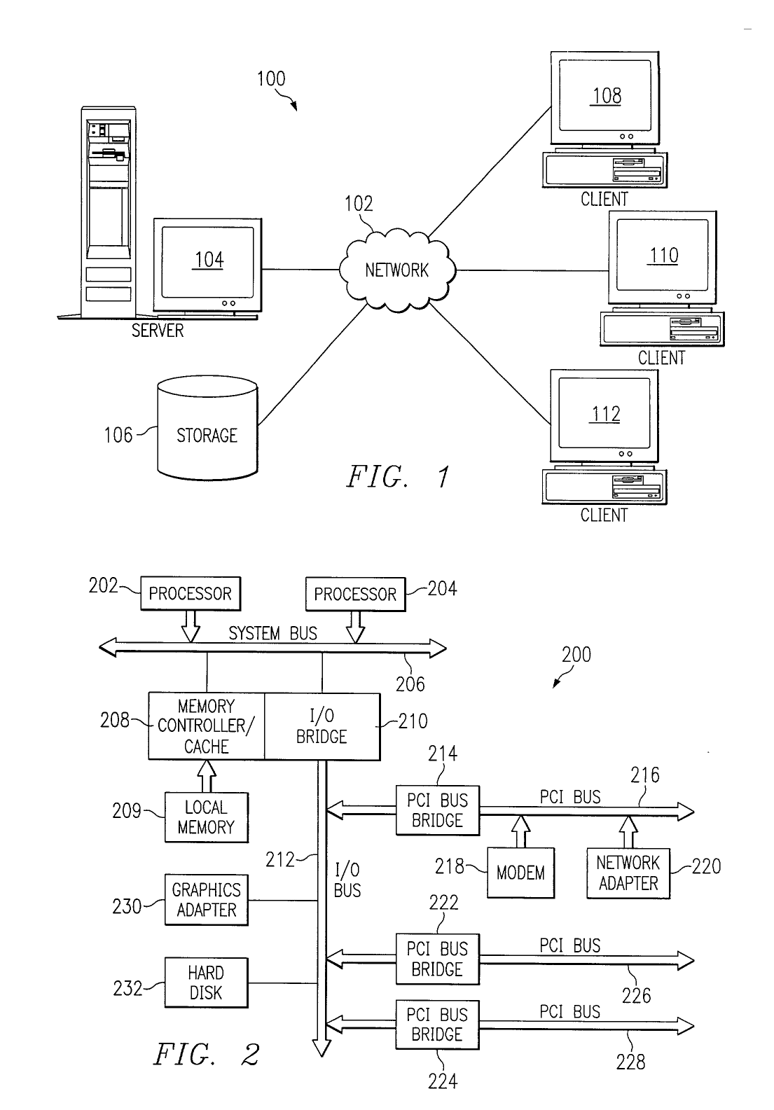

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 maybe integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

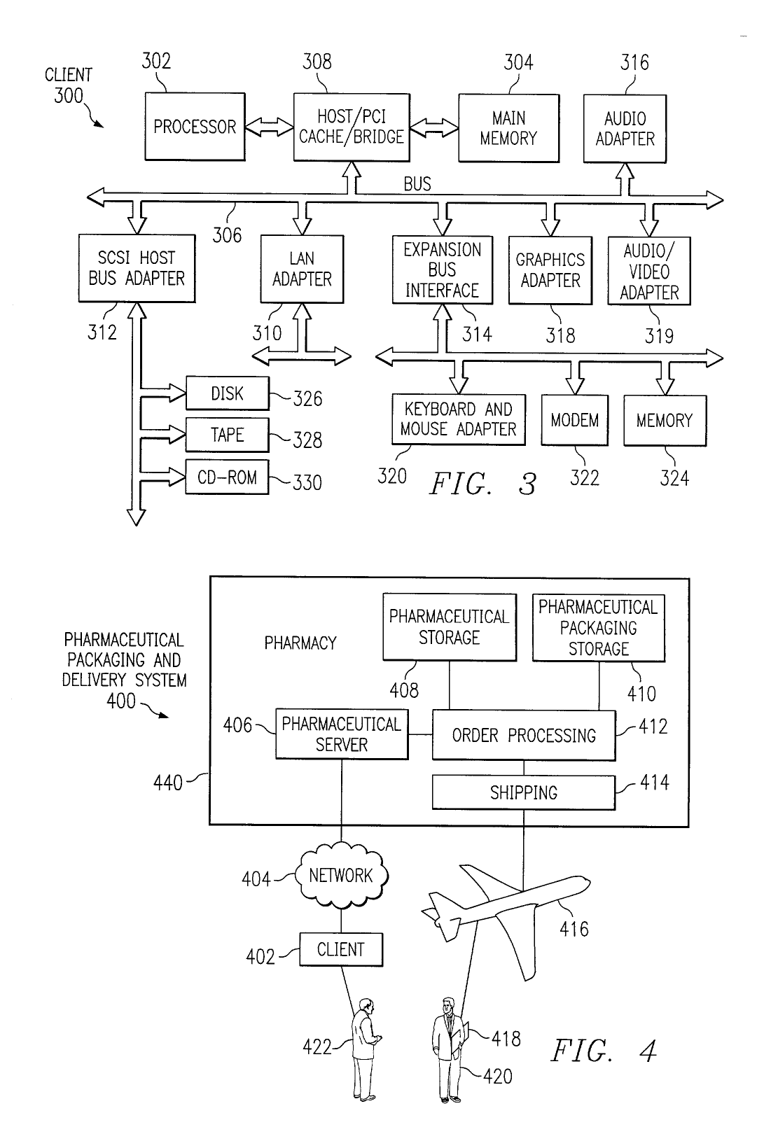

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference now to FIG. 4, a diagram illustrating a pharmaceutical packaging and delivery system is depicted in accordance with the present invention. Pharmaceutical packaging and delivery system 400 is a system for providing pharmaceuticals to persons in custom packaging such that each drug or pharmaceutical dose that a person needs to take at any given time is contained in a single section of packaging, such as a single section of a blister or foil pack. Blister packs and foil packs are types of packaging medications that are well known in the art and commonly used for “over the counter” drugs. For example, if the person needs to take drug A, drug B, and drug C in the morning and drug A and drug D in the evening, a package with, for example, a blister pack for each morning and evening for each day is created. Each morning section of the blister pack contains one dose of drugs A, B, and C and each evening section of the blister pack contains one dose of drugs A and D. The packaging over each blister contains labeling indicating the day and time at which the dose contained in that blister should be taken. Thus, a patient may look at the packaging and determine whether they have taken their medicine and avoid taken a double dose of the medicine because they have forgotten that they have already taken their medication. Also, if the patient has missed a scheduled dose, the patient will be able to determine this because the packaging with the appropriate dosage has not been opened. Thus, the patient can take appropriate action. This action may simply be, for example, to take the missed dosage or to call the patient's physician or pharmacist for instruction. Pharmaceutical packaging and delivery system 400 includes a pharmaceutical server 406, order processing unit 412, pharmaceutical storage 408, pharmaceutical packaging 410, network 404, client 402, and transport 416. Network 404 may be implemented as, for example, network 102 in FIG. 1. Pharmaceutical server 406 may be implemented as, for example, server 200 in FIG. 2 and client 402 may be implemented as, for example, data processing system 300 in FIG. 3.

Client 402 enables a patient 422, or the patient's doctor or pharmacist or other agent, to contact a pharmaceutical server 406 via network 404 to send the patient's 422 prescription or prescriptions via e-mail or through filling out a form on a web page to an on-line pharmacy to be filled. Alternatively, the patient 422, patient's doctor, or other agent of the patient may telephone or fax in the prescription or hand deliver the prescription to the pharmacy 440. Upon receiving the prescription, if the prescription contains an order for several medications, the pharmaceutical server 406 may check a database to determine if there or any potential interactions between the medications or if there is a recommendation that certain medications that have been prescribed not be taken with each other. The pharmaceutical serer 406 may also notify a pharmacist of the prescription, allowing the pharmacist to review the prescription and authorize the prescription to be filled.

Once the prescription has been authorized to be filled, the pharmaceutical server 406 sends the prescription to order processing 412 which obtains the appropriate quantity of the medication or medications from pharmaceutical storage 408. Order processing 412 also obtains pharmaceutical packaging from pharmaceutical packaging storage 410. The packaging obtained from pharmaceutical packaging storage 410 contains several compartments within each package, wherein each compartment holds the medication for a particular day and time of day. Order processing 412 places the appropriate quantities and types of medications that should be taken at a particular time of day on a particular day in the several compartments of the package. Once the compartments are filled, the compartments are covered or sealed with packaging that includes labeling indicating the day and time of day for which the dosage in each compartment should be taken. In a preferred embodiment, this labeling is printed on the labeling located immediately above the compartment for which the corresponding dosage is contained. In addition to the time at which each dosage should be taken, other instructions and warnings may also be printed on the packaging. The packaging could be, for example, a blister pack or a foil pack. However, other types of packaging may be used as well. Methods of filling and sealing blister packs and foil packs with medication are well known in the art.

Once the prescription has been filled and is ready for shipping, order processing 412 sends the packaged medication 418 to shipping 414 which ships the medication to the patient 422 through transport 416. The packaged medication 418 is then delivered to the patient 422 by, for example, a delivery person 420.

If the patient notices that a dose has been skipped because a compartment corresponding to a scheduled dose has not been opened and it is past the time for the dose, the patient may access a web site corresponding to the pharmacy 440 to determine what action to take. The patient may then supply the pharmacy with a patient name, patient ID, prescription number, and/or password to access the patient's information. The patient may then indicate that a particular dosage has been missed by indicating, for example, the time of the scheduled dosage that was missed. The pharmacy 440 will then correlate the time with the medications that should have been taken and determine what action should be taken by the patient. For example, the advice may simply be to take the missed dose immediately and then continue with the schedule, to just skip the missed dose and continue with the remainder of the medication, or a revised schedule may be generated and transmitted to the patient. The patient may then print out the revised schedule on adhesive paper and affix the revised schedule over the previous schedule on the packaging. Of course other actions may be taken as well as will be recognized by one skilled in the art.

The information associated with the prescription may also be stored on server 406 or related storage device such that a replacement or revised copy of the labeling instructions may be printed and sent to the patient to place over the packaging.

FIG. 4 is intended as an example and not an architectural limitation of the present invention. For example, in other embodiments, rather than filling the prescription at an on-line pharmacy via a network such as the Internet, the prescription may be taken directly to a bricks and mortar pharmacy which then packages the dosages into individual compartments of packaging with appropriate labeling to aid the patient in taken the appropriate medications at the appropriate time. Furthermore, in other embodiments, the patient may purchase a packaging equipment to package their medication appropriately after the prescription has been filled. In other embodiments, the packaging may take place at the factory or by a doctor.

With reference now to FIGS. 5-7, a diagram illustrating pharmaceutical packaging is depicted in accordance with the present invention. FIG. 5 shows a package 500 containing several compartments 501-506 in which dosages of medication may be placed. Each compartment contains a dose of medication for a particular day and time. In the depicted example, the patients medication includes three types of medicine: medication A 510-511, 514, 516-517, and 520, medication B 512, 515, 518, and 521, and medication C 513 and 519. The medications 510-521 have been divided out into appropriate dosages for appropriate times in preparation for placing the medication 510-521 into the appropriate compartments 501-506 of packaging 500.

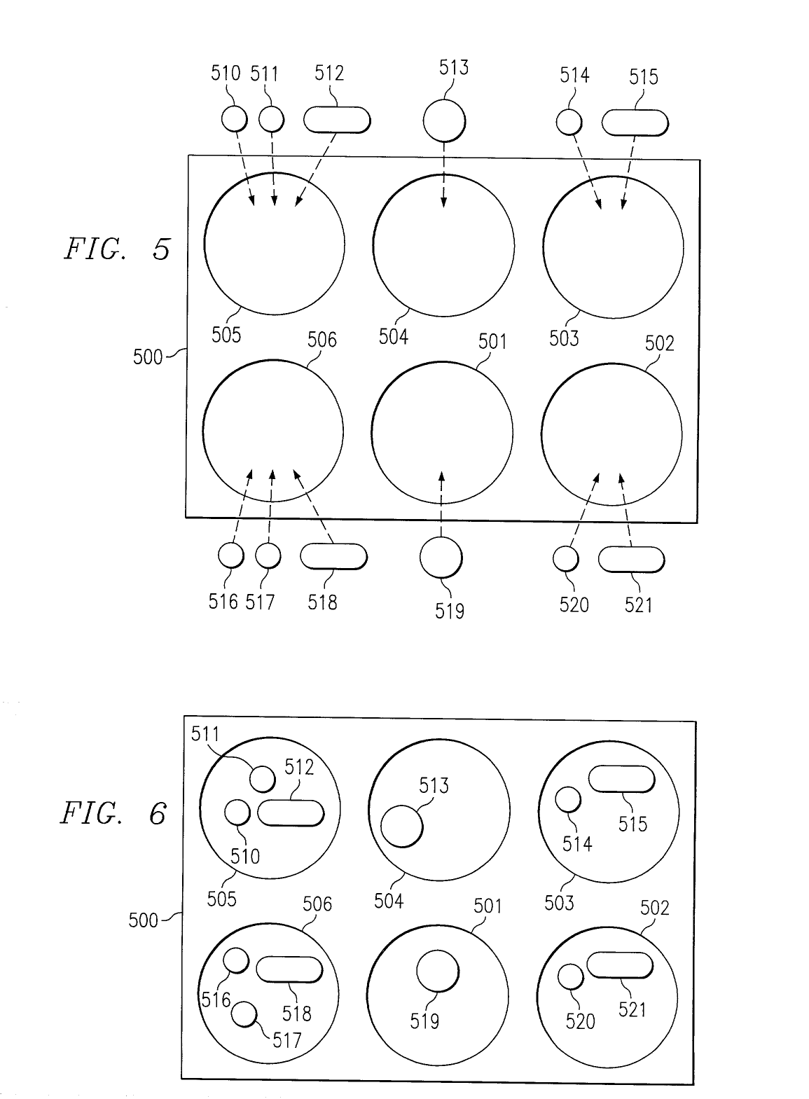

In FIG. 6, the medications 510-521 have been placed into respective compartments 501-506 of packaging 500. In the depicted example, two tablets 510-511 of medication A and one tablet 512 of medication B have been placed into compartment 505. One tablet 513 of medication C has been placed into compartment 504 and one tablet 514 of medication A and one tablet 515 of medication B have been placed into compartment 503. Compartments 506, 501, and 502 are filled in similar fashion. In one example, the depicted packaging may correspond to a prescription in which the patient should take two tablets of medication A and one tablet of medication B in the morning, one tablet of medication B at noon, and one tablet of medication A and one tablet of medication B in the evening. Thus, package 500 may contain two days of medication with compartments 505, 504, and 503 containing morning, noon, and evening doses respectively for day one and compartments 506, 501, and 502 containing morning, noon, and evening doses respectively for day two.

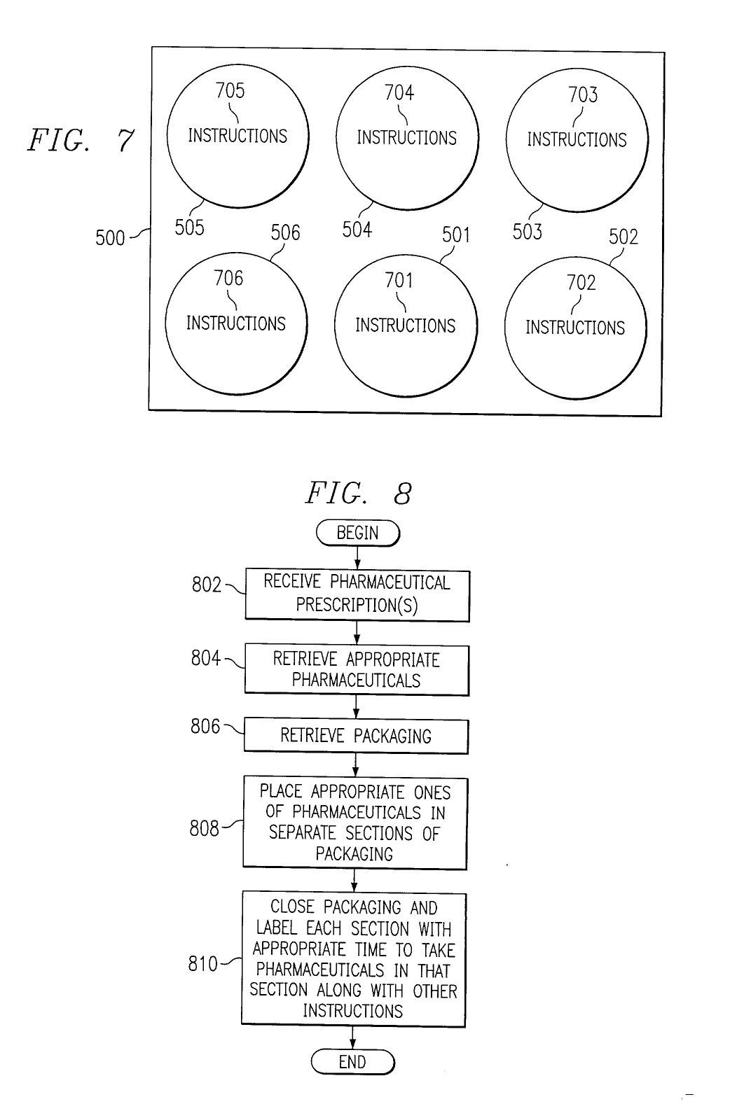

Referring now to FIG. 7, the packaging 500 is depicted after the top layer of packaging has been applied. The top layer of packaging seals or otherwise closes and protects the medication within each of compartments 501-506. The top layer of packaging material is printed with instructions 701-706 which preferably should be located above the compartment 501-506 containing the dosage of medications 510-521 to which the instructions 701-706 apply. However, other locations for instruction placement is possible so long as it is obvious to a patient as to which compartment 501-506 the instructions correspond. The instructions 701-706 include the day and time for which the dosage corresponding to the instruction should be taken by the patient. The instructions 701-706 may contain other information as well such as, for example, a list of the medications included in the dosage in the corresponding compartment 501-506, directions for use, warnings, and precautions. The packaging 500 may be constructed from plastic, paper, cardboard, foil, or any of any other packaging material suitable for protecting and storing medications. However, whatever materials are chosen, packaging 500 is constructed in a manner such that when a dosage is taken from compartments 501-506, strong physical evidence remains that the dosage has been taken. For example, if blister packs are used, removing the medication from the blister pack leaves a whole in the packaging and an empty compartment, thereby indicating to the patient that the medication has been taken.

Packaging 500 is an example of packaging that provides a user with medication in which medications to be taken at substantially the same time are packaged and grouped together with an indication of the time in which the medication should be taken in accordance with the present invention and is not meant to describe an exhaustive list of types of packaging that are consistent with the present invention.

With reference now to FIG. 8, a process flow and program function illustrating a method for packaging mediations is depicted in accordance with the present invention. To begin, one or more pharmaceutical prescriptions are received by a pharmacy (step 802). The pharmacist or automated system retrieves the appropriate medications (step 804) and a suitable packaging (step 806). The pharmacist or system then groups the medications in quantities and types according to when the medications should be taken and places the medications into separate sections of packaging (step 808). Each separate section of packaging contains only medications that should be taken substantially simultaneously. The packaging is then closed or sealed and each section is labeled with an appropriate time for which the medication within that section should be taken as prescribed by the prescription (step 810). The labeling may also include other instructions as well, such as, for example, the name of the mediation or medications, the name of the patient, directions for use, and warnings. Also, the time and date may be specific such as, for example, 8:00 am on Apr. 25, 2001 or may be more generic such as, for example, morning on 1^{st} day. Also, the labeling may be printed directly onto the packaging or may be printed onto a label and affixed to the packaging with for example, glue.

Although described primarily in terms of prescription medications, the present invention may also be used with non-prescription medications or with a combination of prescription and non-prescription medications. Furthermore, the packaging may include snacks in the compartments with the medications for medications that require that the medication not be taken on an empty stomach.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of packaging medications on demand, the method comprising:
grouping medications into dosage groups, wherein the dosage groups contain at least one element of medication and each element of medication in a dosage group should be taken by a patient at substantially the same time as other elements of medication in the same dosage group;
placing each dosage group of medication into a separate compartment in a package;
covering the compartments of the package and labeling compartments with patient customized information indicating a time for which the associated medications within the compartment should be taken by a patient, wherein covering the compartments provides a cover such that removal of a dosage group provides an indication to a patient that the dosage group has been taken by the patient.

2. The method as recited in claim 1, wherein the packaging comprises one of a blister pack and a foil pack.

3. The method as recited in claim 1, wherein labeling compartments further comprises providing instructions about use of at least one of the medications.

4. The method as recited in claim 1, further comprising:
including a food item in at least one compartment wherein the food item is to be taken with the dosage group contained in the at least one compartment.

5. The method as recited in claim 1, further comprising:
transmitting an order for medication to a pharmacy via a network.

6. The method as recited in claim 1, further comprising:
producing revised instructions to affix to the packaging.

7. The method as recited in claim 6, wherein the revised instructions comprise a revised dosage schedule.

8. A computer program product in a computer readable media for use in a data processing system for controlling a medication packager, the computer program product comprising:
first instructions for instructing a the medication packager to group medications into dosage groups, wherein the dosage groups contain at least one element of medication and each element of medication in a dosage group should be taken by a patient at substantially the same time as other elements of medication in the same dosage group;
second instructions for instructing the mediation packager to place each dosage group of medication into a separate compartment in a package;
third instructions for instructing the medication packager to cover the compartments of the package and labeling compartments with patient customized information indicating a time for which the associated medications within the compartment should be taken by a patient, wherein covering the compartments provides a cover such that removal of a dosage group provides an indication to a patient that the dosage group has been taken by the patient.

9. The computer program product as recited in claim 8, wherein the packaging comprises one of a blister pack and a foil pack.

10. The computer program product as recited in claim 8, wherein labeling compartments further comprises fourth instructions for instructing the medication packager to provide instructions about use of at least one of the medications.

11. The computer program product as recited in claim 8, further comprising:
fourth instructions for instructing the medication packager to include a food item in at least one compartment wherein the food item is to be taken with the dosage group contained in the at least one compartment.

12. The computer program product as recited in claim 8, further comprising:
fourth instructions for receiving an order for medication via a network.

13. The computer program product as recited in claim 8, further comprising:
fourth instructions for instructing the medication packager to produce revised instructions to affix to the packaging.

14. The computer program product as recited in claim 13, wherein the revised instructions comprise a revised dosage schedule.

15. A system of packaging medications on demand, the system comprising:
a medication grouper which groups medications into dosage groups, wherein the dosage groups contain at least one element of medication and each element of medication in a dosage group should be taken by a patient at substantially the same time as other elements of medication in the same dosage group;
a placement unit which places each dosage group of medication into a separate compartment in a package;
a package sealer which covers the compartments of the package; and
a labeler which labels compartments with patient customized information indicating a time for which the associated medications within the compartment should be taken by a patient, wherein covering the compartments provides a cover such that removal of a dosage group provides an indication to a patient that the dosage group has been taken by the patient.

16. The system as recited in claim 15, wherein the packaging comprises one of a blister pack and a foil pack.

17. The system as recited in claim 15, wherein the labeler provides instructions about use of at least one of the medications.

18. The system as recited in claim 15, wherein the placement unit includes a food item in at least one compartment wherein the food item is to be taken with the dosage group contained in the at least one compartment.

19. The system as recited in claim 15, further comprising:
a receiver for receiving an order for medication via a network.

20. The system as recited in claim 15, wherein the labeler produces revised instructions to affix to the packaging.

21. The system as recited in claim 20, wherein the revised instructions comprise a revised dosage schedule.
